(19) United States
(12) Patent Application Publication
(10) Pub. No.: US 2007/0075455 A1
(43) Pub. Date: Apr. 5, 2007

(54) Method of sealing a free edge of a composite material

(75) Inventors: Bonnie D. Marini, Oviedo, FL (US); Gary B. Merrill, Orlando, FL (US); Jay E. Lane, Mims, FL (US)

Correspondence Address: Siemens Corporation;Intellectual Property Department, 170 Wood Avenue South, Iselin, NJ, 08830, US

(73) Assignee: Siemens Power Generation, Inc.

(21) Appl. No.: 11/243,147

(22) Filed: Oct. 4, 2005

(51) Int. Cl. B29C 45/14; D04H 5/00; D04H 1/00; B05D 3/02; D04H 13/00; D04H 3/00

(52) U.S. Cl. 264/263; 428/292.1; 427/372.2

(57) ABSTRACT

A method of coating an edge surface (30) of an anisotropic ceramic matrix composite material (10) for use in a high temperature environment is disclosed where the edge surface (30) has exposed reinforced fiber layers (20). A laser beam may be used to melt a portion of the ceramic matrix composite material (10) on the edge surface (30) forming a melt layer. The melt layer is retained proximate the edge surface and the laser beam is controlled to form an isotropic protective coating (32, 34) on a portion of the edge surface (30). A method may be used to form a component for use in a high temperature environment that includes directing a laser beam toward a ceramic matrix composite material (10), controlling the laser beam to melt a portion of the ceramic matrix composite material (10) and forming a homogeneous protective coating (32, 34) from a melt layer that exerts compression on at least a portion of the ceramic matrix composite material (10) when the melt layer is cooled. A powder material (35) may be added to a surface of the ceramic matrix composite material (10) selected to melt with the ceramic matrix composite material (10) to improve the wear resistance or hardness of the isotropic protective coating (32, 34).

### FIELD OF THE INVENTION

This invention relates in general to materials technology and more particularly to a method of sealing an edge of exposed material such as a 2-dimensional laminated composite structure.

### BACKGROUND OF THE INVENTION

Ceramic materials generally have excellent hardness, heat resistance, abrasion resistance, and corrosion resistance and are desirable for high temperature machine applications such as gas turbines and the like. However, ceramic materials are easily fractured by tensile stresses and exhibit a high degree of brittleness. To improve upon the fracture toughness of a ceramic material, it is known to provide a ceramic matrix composite (CMC) material wherein a plurality of inorganic fibers are disposed in a matrix of ceramic material.

A CMC material may be formed by impregnating a preform of fiber containing fabric material with ceramic material powder using a known wet method such as slip casting or slurry infiltration. Alternate methods include impregnating a fiber tow and winding the tow on a mandrel to form a desired shape, or removing the wound tow from the mandrel, cutting it and using it to lay-up shapes. The cast, laid-up or wound part is then dried using low pressures and temperatures to form a green body. The green body is then sintered by known techniques such as atmospheric pressure sintering or reaction sintering to sinter the matrix to its final density to form the CMC material.

The material properties of CMC material are typically anisotropic. This is because the properties of the matrix binder material may differ from the properties of the continuous fiber phase within the woven fabric layer. A fundamental problem with this type of material system is its susceptibility to free edge stresses under thermal and mechanical loads. This may result in delaminating or effective separation of the laminated structure, which may lead to failure of not only the CMC material but also a component formed from the CMC material. Further other components that support the CMC material may be susceptible to failure if the CMC material delaminates.

### BRIEF DESCRIPTION OF THE DRAWINGS

FIG. 1 is a partial cross-sectional view of a ceramic matrix composite material having an adhesive and a protective coating deposited thereon.

FIG. 2 is a partial cross-sectional detailed view of the ceramic matrix composite material of FIG. 1.

FIG. 3 is a partial cross-sectional detailed view of the ceramic matrix composite material of FIG. 2 having an exemplary coating deposited on a free edge thereof.

FIG. 4 is a partial cross-sectional view of a ceramic matrix composite material having an exemplary coating deposited on a free edge thereof.

FIG. 5 is a partial cross-sectional view of the ceramic matrix composite material of FIG. 1 cut in two pieces having an exemplary coating deposited on free edges thereof.

### DETAILED DESCRIPTION OF THE INVENTION

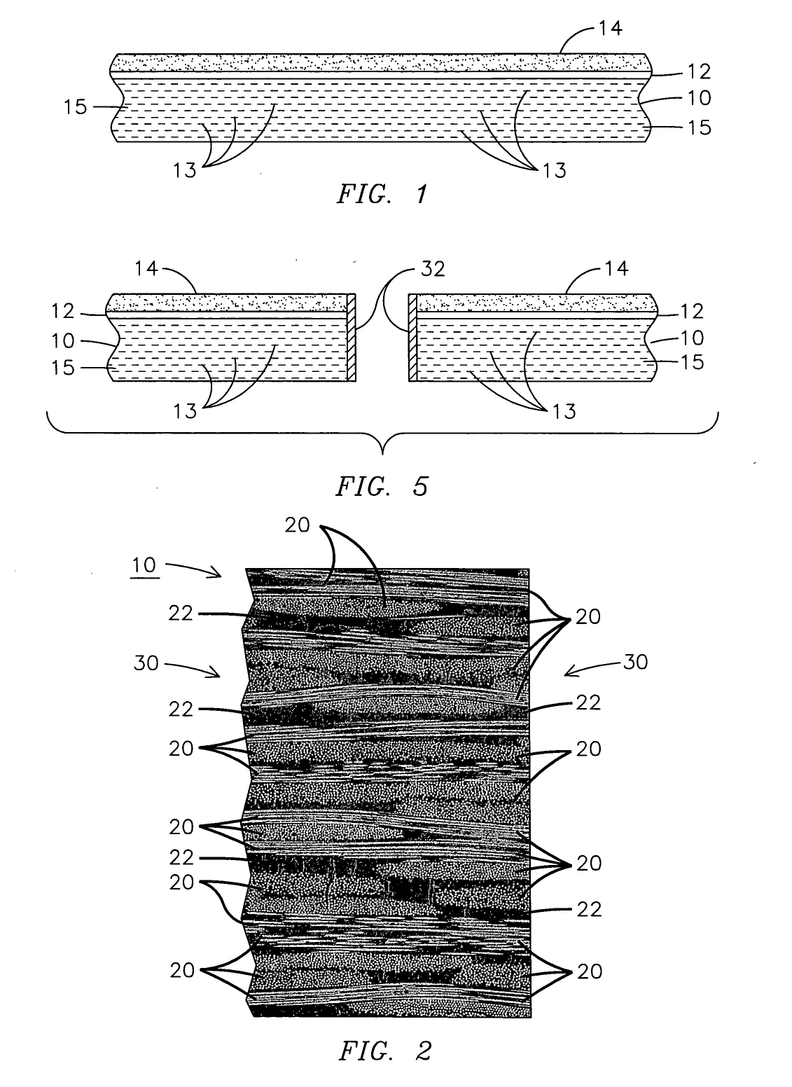

FIG. 1 illustrates a partial cross-sectional view of a ceramic matrix composite (CMC) material 10 having an adhesive 12 and a protective coating 14 deposited thereon. An exemplary CMC material 10 may have a plurality of layers of ceramic fibers 13 disposed with a ceramic matrix material 15. CMC material 10 may be used to cover or form various components as recognized by those skilled in the art. Another exemplary CMC material 10, shown in FIG. 2, may have a plurality of fabric laminate layers 20 interposed among a plurality of matrix material layers 22 to form a 2-dimensional composite layer CMC material 10. Layers 20 may be woven or wound so that fibers are in two directions and essentially in one plane. For typical 2-dimensional fiber structures, the two principle fiber directions are typically, but not necessarily, orthogonal as appreciated by those skilled in the art.

Laminate layers 20 may be, for example, woven fabric such as oxide based ceramic fibers selected from the group of refractory oxide fibers including Al₂O₃, Al₂O₃—SiO₂, mullite, YAG, and Al₂O₃-YAG eutectics. Matrix material layers 22 may be, for example, an oxide based ceramic material and may be one selected from the group of Al₂O₃, Al₂O₃—SiO₂, mullite, YAG, and LaPO₄. The present invention may be applied to any such reinforced matrix composite material including non-oxide based, and may be applied for use in high temperature environments, such as gas turbine engines.

2-dimensional composite layers or laminated oxide CMC materials 10 typically exhibit anisotropic properties in that they provide excellent in-plane mechanical properties but by comparison exhibit poorer properties in the transverse direction. It will be appreciated that CMC materials 10 may have “free” edges such as the lateral edges or ends of the material forming the perimeter of a piece of CMC material 10 when fabricated, or cut to shape or length. For example, as appreciated from FIG. 2, a free edge 30 may be described as the transverse direction in a 2-dimensional fabric laminated type structure, or thickness, such as CMC material 10 when viewed at a directly perpendicular angle. Free edge 30 may expose layers of infiltrated woven fabric 20 and matrix only material 22.

CMC materials 10 having free edges are susceptible to stresses arising from both thermal and mechanical loads, which may result in the initiation of a delaminating crack that may grow to the point of causing failure in the composite structure. Methods of the present invention allow for using lasers to create a dense edge surface that will both improve the resistance of the CMC material 10 to edge stresses and increase the wear and/or hardness properties of the material, which is a long-term concern with respect to surfaces that make contact during use.

It is known to cut and shape CMC material 10 by using water jet cutting and fine grinding operations to finish the CMC material 10. These techniques typically result in edge surfaces having exposed fabric laminate layers 20 and matrix material layers 22, i.e., free edges. This can be appreciated from FIG. 2. The inventors of the present invention have determined that such free edges of CMC material 10 may be sealed during laser cutting, or sealed with lasers after having been fabricated or cut.

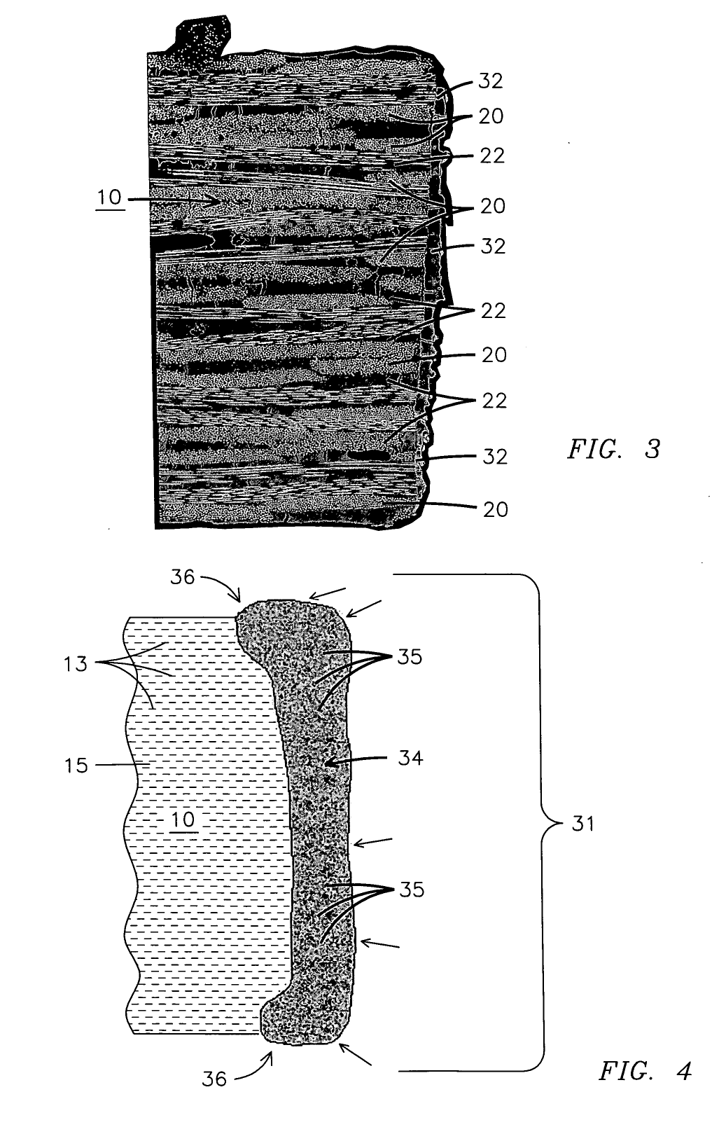

Exposed or free edge surface 30 has exposed fabric laminate layers 20 and matrix material layers 22 similar in arrangement to those shown in the cross-sectional view of FIG. 2. Free edge surface 30 may be sealed using laser cutting, which may be optimized to deposit a melt or recast layer or coating 32 (FIG. 3) on edge surface 30. An embodiment allows for controlling a laser beam to melt a portion of CMC material 10 exposed as edge surface 30, which may be a newly exposed edge surface 30 as CMC material 10 is being laser cut. At least a portion of the melted CMC material 10 may be retained proximate edge surface 30 during laser cutting to form coating 32. Coating 32 may be formed from the retained CMC material on at least a portion of edge surface 30 so that a compressive force 31 (FIG. 4) is exerted on at least a portion of edge surface 30 when the melted CMC material 10 is cooled. The melt layer 32 is at a locally higher temperature than remaining or un-melted CMC so that contraction of the melt layer 32 upon cooling creates a compressive force or clamping effect 31 on a portion of CMC edge 30. The higher density of the melt layer 32 over that of the remaining, lower density CMC material 10 and CMC edge surface 30 may aid forming of this compressive force 31.

Layer or coating 32 is formed as a result of local deposition of retained molten CMC material 10 that is generated as a function of the laser cutting action. Coating 32 may be formed as a consistent homogenous, dense coating on edge surface 30 created during laser cutting of CMC material 10. The thickness of coating 32 may be controlled to avoid spallation of coating 32 off the free edge surface 30. The thickness of coating 32 may be optimized as a function of various parameters such as material composition or the addition of powder to edge surface 30 before or during melting, as well as lasing process parameters. During cool down, the glassy/non-crystalline type melt of CMC material 10 (which can be at temperatures in excess of 2000° C.) solidifies to form a monolayer consisting of the constituents of the laser-processed material, which shrinks onto the newly formed edge surface 30 upon cooling.

One beneficial aspect with respect to a free edge surface 30 of a 2-dimensional laminated CMC material 10 underlying coating 32 is that the melt layer or coating asserts a state of compression on the immediate surface areas of edge surface 30 to which it is contacted. Melt layer or coating 32 will be in residual tension but is denser and stronger than the CMC matrix material 22 and has higher strength margin to accommodate these tensile stresses. The result on the free edge properties of the 2-dimensional CMC material 10 is to increase its resistance to interlaminar separation. Another beneficial aspect is that the wear resistance of the CMC material 10 is increased along free edge surface 30, which is now covered with coating 32. This improved wear resistance increases the useful life and improves performance of CMC materials 10 used in situations where a free edge at least partially covered with coating 32 is continuously or periodically contacting a neighboring structure or component.

Embodiments of the invention allow for various laser-cutting processes to be optimized to deposit melt layer or coating 32 on a newly formed edge surface 30 of the CMC material 10 being cut. Known techniques for cutting CMC material 10 using a laser would typically include applying a gas under pressure to “wash out” the waste from the laser cutting process. The inventors of the present invention have determined that the melted CMC material 10 may be retained during the cutting process and the laser parameters controlled so the retained material may be deposited onto the newly created edge surface 30 to form coating 32.

Aspects of the invention allow for using laser processing to shape the CMC material 10 and to seal edge surface 30 with coating 32. Traditional water jet cutting and fine grinding operations to finish CMC material 10 typically results in exposed free edges susceptible to damaging the CMC material. Laser finishing may be optimized to deposit coating 32, which produces a seal of higher density than the base CMC material 10 exposed along edge surface 30. The base CMC material 10 is a heterogeneous system including two different material phases: a) a monolithic ceramic matrix 22 and a ceramic fiber 20, together having anisotropic properties. Embodiments of the invention allow for applying a laser to the base CMC material 10 to melt the material and form a single phase isotropic, i.e., homogenous material that solidifies to form seal 32. The properties of seal 32 prevent or minimize the likelihood of crack initiation and propagation in the matrix material layers 22 that lie between fabric layers 20.

The laser melt seal formed by coating 32 is harder than the materials of layers 20, 22 and is more resistant to crack initiation and contact stresses. This improves the structure of CMC material 10 proximate edge surface 30 in terms of resistance to interlaminar stresses and handle ability. In this respect, coating 32 prevents loose edges of fabric layer 20 or matrix layer 22 from catching on an object or wearing away due contacting other surfaces. Laser induced coating 32 may be a single, homogenous material that doesn't have any separation or de-lamination points such as ones that might occur between fabric layer 20 and matrix layer 22. Thus, coating 32 operates as a seal along edge surface 30 that may function as an interface to any other external system, such as a component within a gas turbine.

Embodiments of the present invention may be implemented using the laser processing techniques disclosed in U.S. Pat. No. 6,617,013, which is specifically incorporated herein by reference. Those laser processing techniques and others disclosed herein may be used to create a continuous melt phase of molten CMC material 10 along free edge surfaces 30 exposed during the laser cutting process. Laser cutting parameters may be controlled to control the thickness of melt layer or coating 32 to avoid spalling of the layer when CMC material 10 is in use. Laser cutting parameters may be optimized depending on the composition of CMC material 10, desired thickness of coating 32 and other process parameters. For instance, the laser type, nozzle type, focal length, pulse frequency, pulse width and gas pressure, for example, may be controlled to obtain the desired thickness of coating 32.

In an embodiment, melt layer or coating 32 may be optimized to create a continuous coating on the free edge surface 30 of the CMC material 10. FIG. 3 illustrates a coating 32 deposited on a free edge of CMC material 10. A Neodymium-YAG laser having a characteristic wavelength of 1064 nm directing a laser beam at an angle, which may be 90 degrees or other desired angle, to the CMC material 10 surface may be used for cutting CMC material 10 and producing molten CMC material 10 retained for forming coating 32. Various types of laser equipment may be used for this purpose such as, for example, a computer controlled Laserdyne 790 YAG Laser system with a JK704-LD2 Neodymium-Yag source.

Other process parameters that may be used in conjunction with this equipment are an above surface focal point of 18 mm with a standard nozzle and a 125 mm focal length lens. Average power may be about 200 watts with a pulse frequency of 30 hertz, pulse width of 1 millisecond and a gas, such as nitrogen (N₂), carrier pressure of 1 psi. Pulsed beam or continuous wave lasers may be used such as those producing wavelengths between 249 nm and 10,600 nm, for example, to produce similar effects in the CMC material 10 and coating 32. The process parameters with respect to such lasers may be adjusted to provide molten CMC material 10 that forms melt layer 32 for sealing the edges of the material. Particular material conditions and the need to achieve reasonable production rates may be considered to select the optimal laser settings for a particular application.

Another exemplary embodiment allows for depositing a material such as a powder material onto a free edge surface 30 having exposed material from fabric layer 20 and matrix layer 22. Free edge surface 30 is a relatively porous composition. The powder material may compensate for the porosity in the CMC material 10 to help form a homogenous coating layer 32 during laser melting/processing. The powder material may be deposited or placed in intimate contact with the 2-dimensional CMC exposed along surfaces 30. The deposited powder material may form a layer that provides additional material for forming homogenous sealing layer 32. The powder material may be the same composition and/or may use the same constituents as the CMC material 10, or the powder material may be of a different composition and/or constituents.

In an embodiment, a laser beam may be applied to the deposited powder and CMC material 10 to form coating 32. Melting the powder material and proximate CMC material 10 on edge surface 30 creates a dense homogenous coating 32. Coating 32 may have a density of greater than about 90% formed from the powder, portions of porous fabric material layer 20 and portions of matrix material layer 22. In alternate embodiments, a laser-assisted thermal spray process may be used for depositing the same, or an alternative composition coating to the free edge 30 of CMC material 10. This provides the benefit of a single stage operation and may be directly applicable to thicker edges of CMC material 10 where surface deposition and local heating aspects are more critical to forming a dense homogeneous seal coating. In this aspect, a powder material may be introduced into the laser beam that melts and is subsequently deposited onto an edge surface 30 of the CMC material 10. An exemplary coating 34 formed using a powder material 35 is illustrated in FIG. 4.

Powder material 35 may be chosen based on its general hardness or wear resistance properties and/or coefficient of thermal expansion, for example, or for other performance properties of a coating 32, 34. Depositing powder material 35 on edge surface 30 prior to or contemporaneously with laser treatment may enhance the sealing effect of coating 32, 34 and/or achieve other performance objectives of a finished component, such as a protective coating and/or improved wear resistance of a coating.

This may be accomplished by tailoring the chemistry of powder material 35 to the CMC material 10. In an embodiment, powder material 35 may be similar in chemical composition to the CMC material 10 and may be, for example, mullite, alumina and/or silicate-based material compositions. Powders such as alumina, zircon, zirconia, mullite (crystalline), hafnia, yttrium aluminum garnet (YAG), yttria, spinelle or other compositions may be deposited to improve the hardness or wear resistance of coating 32, 34. These powders as well as others may be selected because they are denser than CMC material 10 and have a linear thermal expansion coefficient within a range, such as (±3), for example, of the CMC material 10. Other powder material compositions may be used to achieve specific performance objectives of a coating 32, 34 as appreciated by those skilled in the art.

For example, powder material 35 may be deposited having a lower coefficient of thermal expansion or a higher thermal conductivity relative to that of the CMC material 10 to achieve performance objectives. Powder material 35 may be used to control a desired height or thickness of coating 32, 34. In one aspect, powder material 35 may be deposited onto free edge surface 30 of the CMC material 10 with a portion deposited marginally onto the surfaces of the adjacent sides of edge surface 30 to create a clamping type effect. In this respect, end portions 36, for example, of an exemplary coating 34 (FIG. 4) may extend or wrap around the lateral corners formed between edge surface 30 and the planar surfaces of CMC material 10.

Depositing powder material 35 having a lower coefficient of thermal expansion than CMC material 10 may create a differential in the coefficients of thermal expansion between coating 34 and CMC material 10 shown in FIG. 4. In this respect, during subsequent heating of a component, such as a component in a combustion turbine engine coating 34 will expand at a lower rate than that of the CMC material 10 as a function of temperature. This expansion differential may impose a compressive force 31 on the CMC free edge surface 30, which improves the structural integrity of CMC material 10. The wrapping around of end portions 36 may produce a gripping effect on edge surface 30 that further improves the structural integrity of that free edge.

FIG. 5 illustrates a partial cross-sectional view of two pieces of CMC material 10, which may have been laser cut from a single piece of CMC material 10. Each piece of CMC material 10 may include a coating 32, 34 deposited on a respective end portion. In an embodiment, 3-dimensional reinforce CMC materials may be susceptible to free edge damage or other adverse affects after machining or cutting. Laser cutting of 3-dimensional CMC material or laser processing of pre-cut 3-dimensional CMC material may be used to form a melt layer, such as layer 32, 34 to seal or protect any exposed or free edges. Such a melt layer may increase the strength or wear resistance of the edges in a manner similar to that discussed above with respect to 2-dimensional CMC material 10.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

We claim as our invention:

1. A method of coating an edge surface of an anisotropic ceramic matrix composite material for use in a high temperature environment, the edge surface having exposed reinforced fiber ends, the method comprising:
controlling a laser beam to melt a portion of the exposed reinforced fiber ends to form a melt layer on at least a portion of the edge surface;
retaining at least a portion of the melt layer on the edge surface; and
allowing the melt layer to cool to form an isotropic protective coating on at least a portion of the edge surface.

2. The method of claim 1 further comprising:
controlling the laser beam to cut the anisotropic ceramic matrix composite material to form the edge surface; and
retaining at least a portion of the melt layer on the edge surface.

3. The method of claim 1 further comprising controlling the laser beam so the isotropic protective coating has a maximum thickness selected to prevent spalling of the isotropic protective coating when the anisotropic ceramic matrix composite material is used in the high temperature environment.

4. The method of claim 1 further comprising:
adding a powder material onto the edge surface; and
controlling the laser beam so that at least a portion of the powder material and at least a portion of the melt layer melt together to form the isotropic protective coating.

5. The method of claim 4, the powder material comprising a composition selected to form the isotropic protective coating to have a coefficient of thermal expansion lower than a through thickness coefficient of thermal expansion of the anisotropic ceramic matrix composite material.

6. The method of claim 4, the powder material comprising a composition selected from the group of alumina, zircon, zirconia, crystalline mullite, hafnia, yttrium aluminum garnet, yttria, spinelle and a silicate-based material composition.

7. The method of claim 1 further comprising controlling the laser beam to cause a portion of the melt layer to overlay a lateral surface of the anisotropic ceramic matrix composite material so the isotropic protective coating exerts a compressive force on at least a portion of the anisotropic ceramic matrix composite material when the melt layer is cooled.

8. The method of claim 1 further comprising controlling a laser-assisted thermal spray process to deposit a powder material on a surface of the anisotropic ceramic matrix composite material, the powder material comprising a composition selected to form the isotropic protective coating to have a coefficient of thermal expansion lower than a through thickness coefficient of thermal expansion of the anisotropic ceramic matrix composite material so that a compressive force is created by the isotropic protective coating on at least a portion of the anisotropic ceramic matrix composite material at operational conditions of the high temperature environment.

9. The method of claim 1 further comprising:
adding a powder material onto the edge surface prior to the step of controlling a laser beam to melt a portion of the exposed reinforced fiber ends, the powder material comprising a composition selected to form the isotropic protective coating to have a coefficient of thermal expansion lower than a through thickness coefficient of thermal expansion of the anisotropic ceramic matrix composite material;
controlling the laser beam so that at least a portion of the powder material and at least a portion of the melt layer melt together to form the isotropic protective coating; and
controlling the laser beam to cause a portion of the melt layer to overlay a lateral surface of the anisotropic ceramic matrix composite material adjacent the edge surface so the isotropic protective coating exerts a compressive force on at least a portion of the anisotropic ceramic matrix composite material when the melt layer is cooled.

10. The method of claim 1 further comprising:
adding a powder material onto the edge surface of the anisotropic ceramic matrix composite material, the powder material comprising a composition selected to create a wear resistant surface of the isotropic protective coating; and
controlling the laser beam so at least a portion of the powder material and at least a portion of the melt layer melt together to form the isotropic protective coating.

11. The method of claim 1 further comprising controlling a laser-assisted thermal spray process to deposit a powder material onto the edge surface of the anisotropic ceramic matrix composite material, the deposited powder material comprising a composition selected to form the isotropic protective coating with the melt layer.

12. The method of claim 11, the powder material comprising a composition selected from the group of alumina, zircon, zirconia, crystalline mullite, hafnia, yttrium aluminum garnet, yttria, spinelle and a silicate-based material composition.

13. A material comprising:
an anisotropic composite material comprising a plurality of ceramic fibers within a ceramic matrix material; and
a recast layer of the anisotropic composite material forming an isotropic protective coating along an edge of the anisotropic composite material and sealing a plurality of ceramic fiber ends therein.

14. The material of claim 13, the plurality of ceramic fibers comprising a 2-dimensional laminate structure.

15. The material of claim 13, the plurality of ceramic fibers comprising a 3-dimensional non-laminate structure.

16. The material of claim 13 further comprising a powder material melted within the recast layer and comprising a composition forming a wear resistant surface of the isotropic protective coating.

17. The material of claim 16, the powder material comprising a composition selected from the group of alumina, zircon, zirconia, crystalline mullite, hafnia, yttrium aluminum garnet, yttria, spinelle and a silicate-based material composition.

18. The material of claim 13 further comprising a powder material melted within the recast layer and comprising a composition at least partially causing the protective isotropic coating to have a coefficient of thermal expansion lower than a through thickness coefficient of thermal expansion of the anisotropic composite material thereby creating a compressive force on at least a portion of the edge by the protective isotropic coating when the material is used in a high temperature environment.

19. The material of claim 13 further comprising a powder material melted within the recast layer and comprising a composition selected from the group of alumina, zircon, zirconia, crystalline mullite, hafnia, yttrium aluminum garnet, yttria, spinelle and a silicate-based material composition.

20. The material of claim 13, the recast layer comprising an overlay portion extending over a surface of the material lateral to the edge.
